(19) United States
(12) Patent Application Publication
(10) Pub. No.: US 2015/0317435 A1
(43) Pub. Date: Nov. 5, 2015

(54) PRESENTING A PATIENT'S DISPARATE MEDICAL DATA ON A UNIFIED TIMELINE

(71) Applicant: Practice Fusion, Inc., San Francisco, CA (US)

(72) Inventors: Stefan Mills KLOCEK, Berkeley, CA (US); Andreas Myhrvold Braendhaugen, San Francisco, CA (US)

(73) Assignee: Practice Fusion, Inc., San Francisco, CA (US)

(21) Appl. No.: 14/268,759

(22) Filed: May 2, 2014

(51) Int. Cl. G06F 19/00

(52) U.S. Cl. CPC G06F 19/322

(57) ABSTRACT

In an embodiment, a computer-implemented method presents medical data. In the method, a request for medical data related to a patient is received. Then, data records in a medical records database that relate to the patient are identified. The medical records database includes a plurality of different types of medical data records, and each data record is associated with a corresponding time. According to the data records' corresponding time, the identified data records are temporally ordered to generate a timeline. Finally, the timeline is output to a device for display, such that the displayed timeline presents the plurality of different types of data records related to the patient together in a single temporal view.

### BACKGROUND

1. Field

This field is generally related to presenting electronic health records on a display.

2. Background

### Electronic Health Records

Medical records related to a patient's health information are essential to the practice of medical care. Traditionally, medical records were paper-based documents. The emergence of electronic medical records (EMR), which are digital version of the paper chart that contains all of a patient's medical history from one medical practice, offers medical professionals and patients with new functionalities and efficiencies that paper-based medical records cannot provide. An electronic health record (EHR), also known as an electronic medical record (EMR), is a collection of electronically stored information about an individual patient's medical history. EHRs may contain a broad range of data, including demographics, medical history, medication history, allergies, immunization records, laboratory test results, radiology images, vital signs, personal statistics like age and weight, and billing information. Many commercial EHR systems combine data from a number of health care services and providers, such as clinical care facilities, laboratories, radiology centers, and pharmacies.

EHRs are a drastic improvement over paper-based medical records. Paper-based medical records require a large amount of physical storage space. Paper records are often stored in different locations, and different medical professionals may each have different and incomplete records about the same patient. Obtaining paper records from multiple locations for review by a health care provider can be time consuming, complicated, and sometimes impossible. In contrast, EHR data is stored in digital format, and thus are more secure and can be accessed from anywhere. EHR systems significantly simplify the reviewing process for health care providers. Because records in EHRs can be linked together, EHRs vastly improve the accessibility of health records and the coordination of medical care.

EHRs also decrease the risk of misreading errors by health care professionals. Poor legibility is often associated with handwritten, paper medical records, which can lead to medical errors. EHRs, on the other hand, are inherently legible given that they are typically stored in typeface. In addition, electronic medical records enhance the standardization of forms, terminology and abbreviations, and data input, which help ensure reliability of medical records, and standardization of codesets and storage of EHR data means that data from different technical information systems can be displayed in a single, unified record. Further, EHRs can be transferred electronically, thus reducing delays and errors in recording prescriptions or communicating laboratory test results.

The benefits of digitizing health records are substantial. Health care providers with EHR systems have reported better outcomes, fewer complications, lower costs, and fewer malpractice claim payments. But despite EHRs' potential in drastically improving the quality of medical care, only a low percentage of health care providers use EHR systems. While the advantages of EHRs are significant, they also carry concerns, including high costs, lost productivity during EHR implementation or computer downtime, and lack of EHR usability.

The Health Insurance Portability and Accountability Act (HIPAA), enacted in the U.S. in 1996, and as amended, established rules for use and access of protected health information (PHI). HIPAA provides restrictions on disclosure of and access to protected health information to and by third parties. HIPAA applies to information in electronic medical records, such as health information doctors and nurses input, documented conversations between a doctor and a patient, and information use to process or facilitate medical billing claims and documents. The HIPAA Security Rule, effective on Apr. 20, 2005 for most covered entities, adds additional constraints to electronic data security and the storage and transmission of PHI.

The high cost of EHRs also significantly hinders EHR adoption. A large number of physicians without EHRs have referred to initial capital costs as a barrier to adopting EHR systems. Cost concerns are even more severe in smaller health care settings, because current EHR systems are more likely to provide cost savings for large integrated institutions than for small physician offices. During the EHR technology's setup and implementation process, productivity loss can further offset efficiency gains. The need to increase the size of information technology staff to maintain the system adds even more costs to EHR usages.

Usability is another major factor that holds back adoption of EHRs. It is particularly challenging to develop user-friendly EHR systems. There is a wide range of data that needs to be integrated and connected. Complex information and analysis needs vary from setting to setting, among health care provider groups, and from function to function within a health care provider group. To some providers, using electronic medical records can be tedious and time consuming, and the complexity of some EHR systems renders the EHR usage less helpful. Some doctors and nurses also complain about the difficulty and the length of time to enter patients' health information into the system.

Under-utilization of EHR systems, despite incentives and mandates from the government and the tremendous potential of EHRs in revolutionizing the health care system, calls for better EHR systems that are secure, cost-effective, efficient, and user-friendly.

Comprehensive EHR systems can provide capabilities far beyond simply storing patients' medical records. Because EHR systems offer health care providers and their workforce members the ability to securely store and utilize structured health information, EHR systems can have a profound impact on the quality of the health care system. In Framework for Strategic Action on Health Information Technology, published on Jul. 21, 2004, the Department of Health & Human Services (HHS) outlined many purposes for EHR services. The outlined purposes include, among other things, improving health care outcomes and reducing costs, reducing recordkeeping and duplication burdens, improving resource utilization, care coordination, active quality and health status monitoring, reducing treatment variability, and promoting patients' engagement in and ownership over their own health care.

Recent legislation has set goals and committed significant resources for health information technology (IT). One of the many initiatives of the American Recovery and Reinvestment Act of 2009 (ARRA) was “to increase economic efficiency by spurring technological advances in science and health.” The Health Information Technology for Economic and Clinical Health (HITECH) Act, passed as a part of ARRA, allocated billions of dollars for health care providers to adopt and meaningfully use EHRs in their practices. HITECH also mandates the Office of the National Coordinator for Health Information Technology (ONC) to define certification criteria for “Certified EHR Technology.”

EHR systems satisfying “Certified EHR Technology” criteria are capable of performing a wide range of functions, including: entry and storage, transmission and receipt of care summaries, clinical decision support, patient lists and education resources, generation of public health submission data, and patient engagement tools. Entry and storage is related to the ability to enter, access and modify patient demographic information, vital signs, smoking status, medications, clinical and radiology laboratory orders and results. Transmission and receipt of care summaries involve the ability to receive, incorporate, display and transmit transition of care/referral summaries. Clinical decision support features configurable clinical decision support tools, including evidence-based support interventions, linked referential clinical decision support, and drug-drug and drug-allergy interaction checks. Patient lists and education resources include the ability to create patient lists based on problems, medications, medication allergies, demographics and laboratory test result values, and the ability to identify patient-specific education resources based on such data elements. Generating public health submission data allows users to create electronic immunization and syndromic surveillance data files that can be submitted to public health agencies. Patient engagement tools allow medical professionals to grant patients with an online means to view, download and transmit their health information to a third party, provide patients with clinical summaries after office visits, and facilitate secure-doctor patient messaging.

### File Organization

Maintaining records of a patient's medical history is essential to quality healthcare. As discussed above, physicians traditionally kept (and many still keep today) patient records in paper files. These files segregated different types of information into different areas. For example, notes on patient encounters may have been in one part of the file, and lab results may have been in another part of the file. This separation may have been a logical organization when different papers were provided in physical formats. But it also required that a doctor flip between different portions of the file to get a complete picture of the patient's past care.

Similarly, standard EHRs also segregate different types of information into different views. Just as a paper file segregated notes on patient encounters and lab results in different areas, an EHR interface typically presents these different types of data in different tabs. To get a complete picture of patient care, a physician has to switch between the different views by, for example, switching between different tabs.

### BRIEF SUMMARY

In an embodiment, a computer-implemented method presents medical data. In the method, a request for medical data related to a patient is received. Then, data records in a medical records database that relate to the patient are identified. The medical records database includes a plurality of different types of medical data records, and each data record is associated with a corresponding time. According to the data records' corresponding time, the identified data records are temporally ordered to generate a timeline. Finally, the timeline is output to a device for display, such that the displayed timeline presents the plurality of different types of data records related to the patient together in a single temporal view.

Method and computer program product embodiments are also disclosed.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 illustrates an interface that presents a patent's disparate medical data on a unified timeline, according to an embodiment.

FIG. 2 is a flowchart illustrating an example method for generating the interface shown in FIG. 1.

FIG. 3 is a flowchart illustrating an example method for generating summaries shown in the timeline in FIG. 1.

FIG. 4 is a diagram illustrating an example system for generating the interface shown in FIG. 1.

FIG. 5 is a diagram illustrating an example computing device, according to an embodiment.

FIG. 6 is an illustration of a conventional medical record.

The drawing in which an element first appears is typically indicated by the leftmost digit or digits in the corresponding reference number. In the drawings, like reference numbers may indicate identical or functionally similar elements.

### DETAILED DESCRIPTION

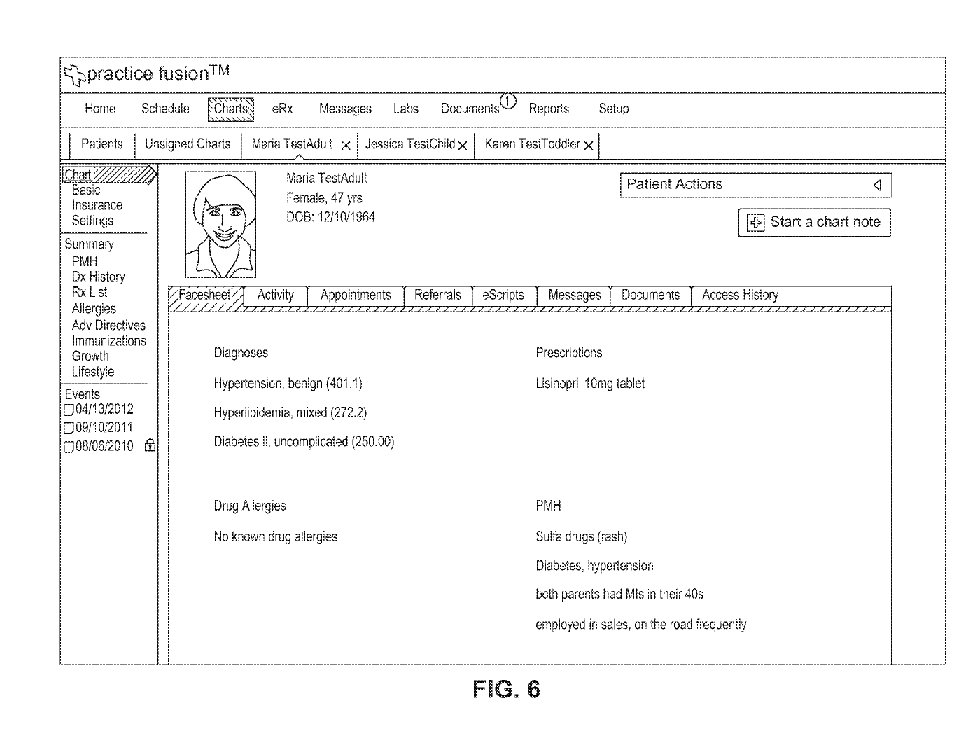

When a physician (or other authorized party) wishes to view the medical history for a given patient, the physician may access the patient's EHR and display the EHR on a corresponding device. In a traditional EHR, each disparate type of data (e.g., patient encounter notes, lab results, etc.) may be presented in a different format (or “view”). Such different views may be provided to a user in separate windows or tabs on the display device. An example EHR that separates user information into different tabs or sections is illustrated in FIG. 6. Such a tabbed interface simplifies development of the EHR system, because the different views can be optimized for displaying their respective data types. Also, doctors may be accustomed to an interface that separates different types of data into different views, because of its similarity to the organization of legacy paper files. But this similarity to legacy paper files also brings with it disadvantages. In particular, like with paper files, a doctor may need to flip back and forth between tabs to get a complete picture of the patient's past care. This can be disorienting and time-consuming. Further, temporal connections may be overlooked or misunderstood.

Embodiments of the present invention address these issues by aggregating different types (including different formats) of data about a patient into a single view. That view organizes the disparate patient data by its associated time. More recent data may be placed first, with subsequent data listed in reverse chronological order. This organization may be useful because the most recent data is often the most relevant to the patient's current condition.

As also mentioned above, when different types of data are segregated into different views, each view can be optimized to display that particular type. But in embodiments disclosed here, the timeline places disparate data types into a single view, so conventional methods of optimizing a view based on data type are not applicable. Embodiments can analyze data records having different types and generate summaries of the data records based on the analysis. Such summaries have a consistent format across all data types, even though the data types themselves do not have a consistent format. In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Timeline Interface

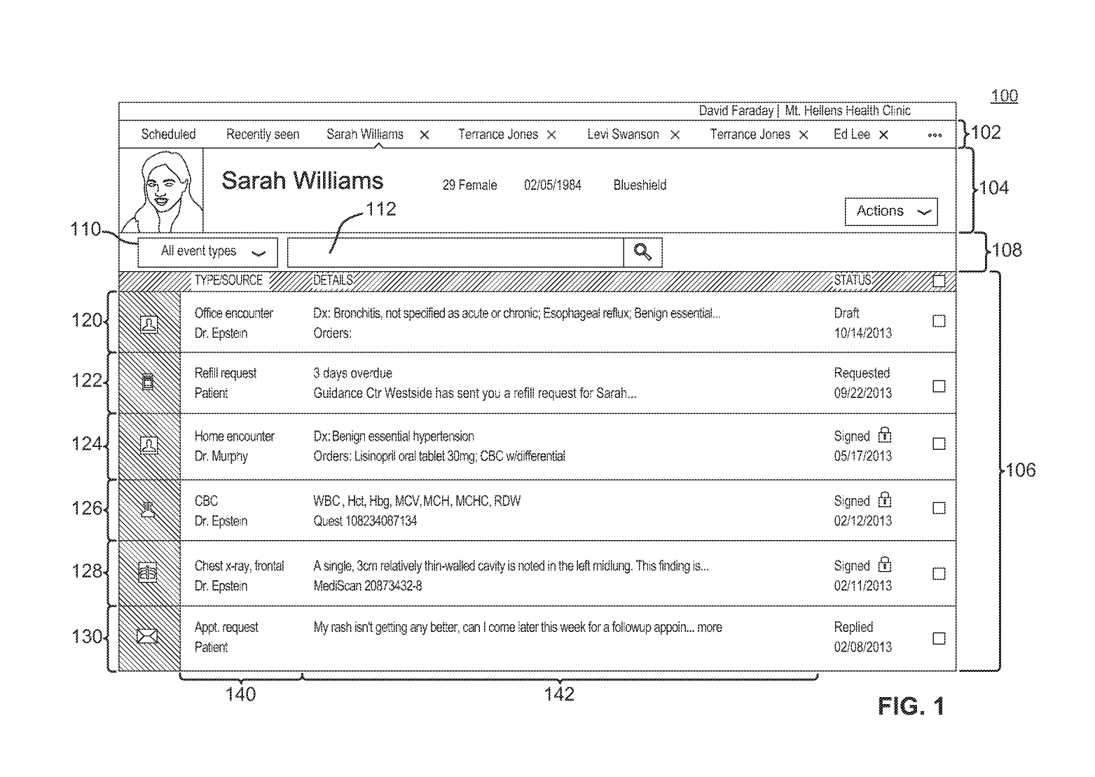

FIG. 1 shows a screen layout 100 illustrating an interface that presents a patient's disparate medical data on a unified timeline, according to an embodiment. The interface may be used, for example, by a physician examining a patient's history of care. In the embodiment shown in FIG. 1, the interface is divided into four frames: frame 102, 104, 106, and 108. Each is discussed in turn.

Frame 102 lists different patients that a physician treats. When the physician selects one of the listed patients, the interface presents information about the selected patient. Information may be presented in frames 104 and 106.

Frame 104 displays biographic information about the patient. The biographic information may include, for example and without limitation, the patient's name, age, gender, date of birth, insurance provider, and likeness (such as a photograph).

Frame 106 displays a timeline with the patient's medical information. Frame 106 displays the timeline in a table with rows and columns. In particular, each record of medical data is displayed as a separate row, and frame 106 includes six rows: row 120, 122, 124, 126, 128, and 130. The timeline rows represent different types of medical records having disparate types of data. In the example of layout 100, rows 120 and 124 represent patient encounters, which are instances where a physician met with the patient. Rows 126 and 128 represent lab results. Row 122 represents a prescription, such as an e-prescription. Row 130 represents a message from the patient.

In the embodiment of FIG. 1, each row includes at least two columns: columns 140 and 142. Column 140 indicates the type of medical record (e.g., encounter, prescription, lab result, or message). In addition, column 140 can list the source of the information (e.g., the patient, or the name of the physician or lab that provided information). Column 142 provides a summary of the medical information represented in each row. As described in detail below, the summary may include different types of information and may be presented differently depending on the type of record and the availability of associated data. But, despite these differences, the summary may be generated such that it can be presented in a regular, uniform manner as illustrated in column 142.

In frame 106, the rows of medical records are ordered based on time. Each medical record has an associated timestamp. For example, for encounters, the timestamp may indicate when the encounter occurred; for prescriptions, the timestamp may indicate when the prescription was authorized or requested; for lab results, the timestamp may indicate when the test was conducted or when the results were reported; and, for messages, the timestamp may indicate when the message was received by the system. In an embodiment, frame 106 orders the records in reverse chronological order, with the records listed from newest to oldest. In this way, a physician can scan through the records to quickly understand the patient's complete history of care, without a full analysis of the entire EHR.

While providing the complete history of care may be useful, there may be instances where a physician would want to filter the data being presented. To reduce the amount of data presented, the interface provides additional user interface (UI) controls in frame 108.

In the embodiment of FIG. 1, frame 108 includes two controls: a drop-down menu 110 and a text box 112. Drop-down menu 110 enables a physician to select a particular type of medical record. Upon making a selection, the interface may be updated to present, in frame 106, only records having that type. For example, if a physician wanted to view only lab results, she could select that type of record from drop-down menu 110, and frame 106 would be updated to display only lab results, removing other types of medical records.

Text box 112 enables a physician to search the patient's medical data. By entering a text string into text box 112, frame 106 may be updated to present only medical records that include the text string, or, in some cases, a variant (such as a regular expression variant) of the text string. In one embodiment, text box 112 may enable the physician to search the medical record summaries. In another embodiment, text box 112 may enable the physician to search the entire EHR for the text string, including data that is not presented in the timeline.

When a physician has identified a record of interest, the physician may select the record. The record may be selected, for example, by double-clicking on the record with a mouse, by touching the record on a touchscreen using a finger, stylus, and the like, by keystroke on a keyboard, etc. Upon selection, another view may appear that presents additional details of the record. Using this open-and-inspect feature, the physician can obtain additional information about records of interest.

In this way, embodiments provide an easy-to-use interface for viewing patient information. A person of skill in the art would understand that modifications may be made to the interface while staying within the spirit and scope of the present invention. For example, the timeline may be arranged chronologically instead of reverse chronologically, so that the oldest record appears first. In an embodiment, the timeline layout is customizable. For example, more or fewer frames could be displayed as needed to provide sufficient information for the physician's purposes. Instead of including frame 102, for example, the interface may provide other patient selection tools, such as a drop-down box or search field. The timeline may also include additional columns, as needed for the physician's purposes.

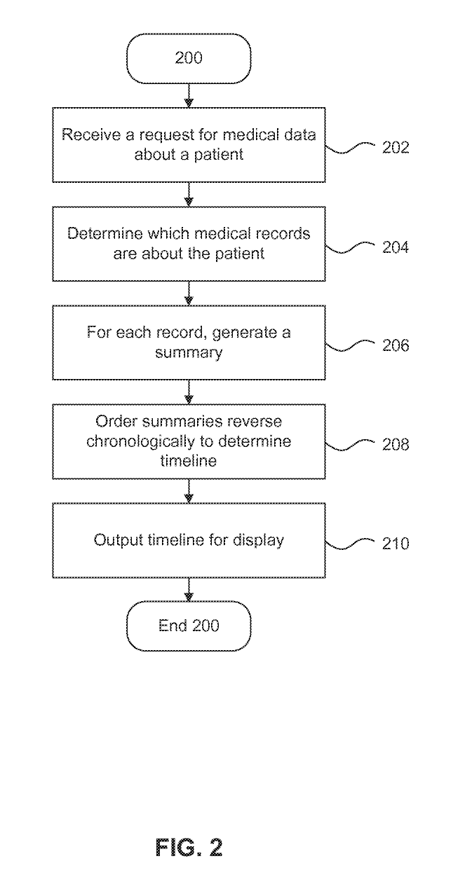

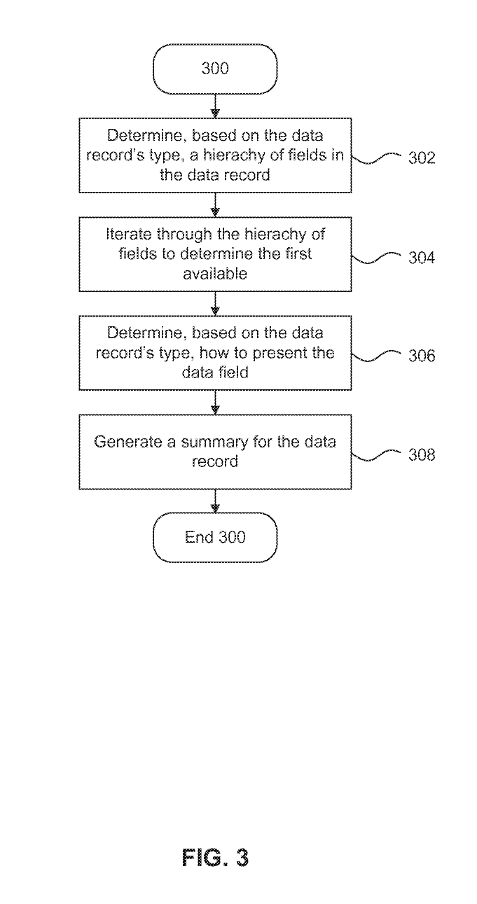

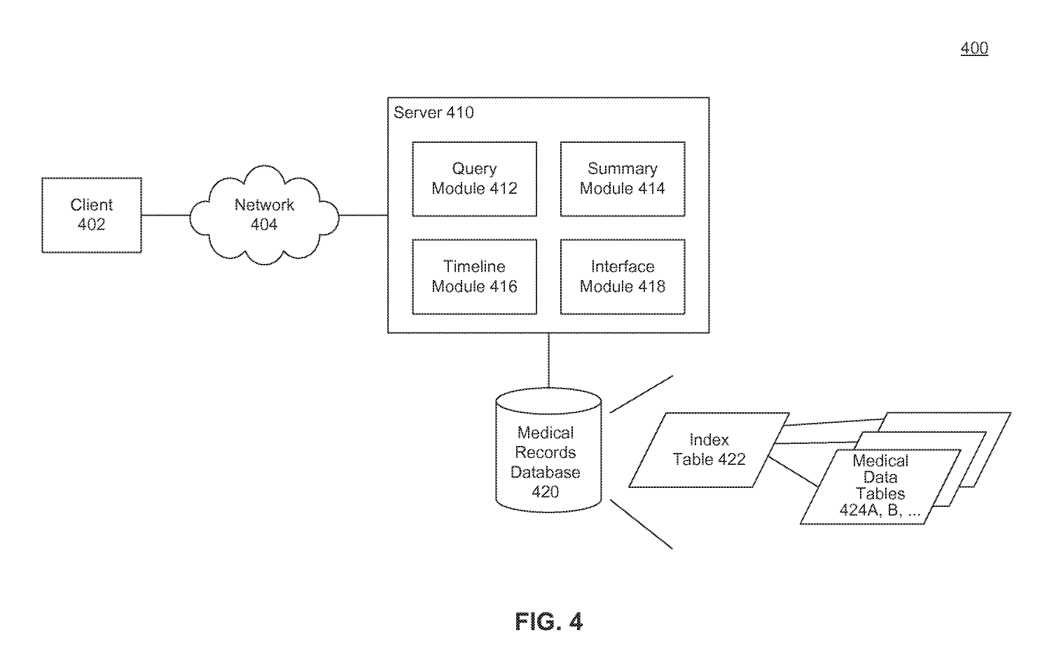

The description of FIGS. 2 and 3 below detail a method for generating the interface, while the description of FIG. 4 describes a system for generating and providing the interface.

### Method

FIG. 2 is a flowchart illustrating a method 200 for generating an interface that presents a patient's disparate medical data on a unified timeline.

Method 200 begins at step 202 by receiving a request for medical data about a patient. The request may originate from a user selection on the screen of a user device and may be transmitted via a network. In one example, the request is transmitted as a hypertext transfer protocol (HTTP) request, and the patient is identified by a parameter of the HTTP request.

To service the request, a medical records database is queried at step 204. The medical records database includes a plurality of different types of medical data. In particular, the medical records database is queried to determine which data records relate to the requested patient. As described in more detail below, this may involve querying several different tables or a single index table. In response to the query, the patient's medical records are retrieved from the database.

Once the patient's medical records are retrieved, a summary of each record is generated at step 206. The summary may include a subset of available data in the data record and may be generated according to each data record's respective type. More detail on how the summary may be generated is provided below with respect to FIG. 3.

Once generated, the summaries are temporally ordered at step 208. For example, the summaries may be ordered reverse chronologically. By temporally ordering the summaries, a timeline representing a history of the patient's care is generated.

Finally, the timeline is output for display at step 210. In one embodiment, the timeline may be output by transmitting the data over a network to the user device. The timeline may be formatted, for example, as a hypertext markup language (HTML) file, and may be transmitted to the user device using web protocols such as HTTP. In this way, the timeline may be displayed using a conventional web browser. This is only an example; a skilled artisan would recognize that other protocols and devices may be used to effect outputting the timeline to a patient's display.

FIG. 3 is a flowchart illustrating a method 300 for summarizing a patient's data records. In an embodiment, method 300 may be completed for each data record retrieved for a given patient.

Method 300 begins at steps 302 and 304 by examining data fields to determine which fields to present in the summary. At step 302, a hierarchy of fields for the data record is determined based on the data record's type. In an example where the data record is a patient encounter, the data record hierarchy may identify fields for, for example and without limitation, the diagnosis, treatment plan, assessment, patient's subjective diagnosis, and patient's chief complaint. The hierarchy may prioritize those fields in order of their usefulness in summarizing the counter. For example, the hierarchy may prioritize fields in the order as listed above, or the hierarchy may prioritize more, fewer, or different fields in an order different from that shown above. Such a hierarchy may, for example, be built into the system, based on user selection, or learned through machine learning.

At step 304, the data record is examined to determine what fields are present in the specific data record. This may involve iterating through the hierarchy of fields and comparing the fields to the data in the data record, to determine the highest priority field from the hierarchy that is present in the data record. Using the patient encounter example, the patient encounter hierarchy may have prioritized a diagnosis as the highest priority field. So the patient encounter data record is first searched to determine whether a diagnosis is available. If a diagnosis is available, it may be selected for the summary. If no diagnosis is available, but a treatment plan is, the treatment plan may be selected. If no diagnosis or treatment plan is available, but an assessment is, the assessment may be selected. If no diagnosis, treatment plan, or assessment is available, but the patient's subjective diagnosis is, the patient's subjective diagnosis may be selected. Finally, if no other fields are available, the patient's chief complaint may be selected. In this way, the hierarchy orders the available fields depending on their relative probative value. And because different data types have different fields, the hierarchy used may vary between types. In the example above, the hierarchy specifies selecting a single field for the summary. But in other embodiments, multiple fields may be selected based on their availability.

Once the field or fields are selected for the summary, the summary is generated at steps 306 and 308. The summary may simply be the field formatted in a particular manner, or it may include additional identifying information. In some embodiments, the summary may be a narrative generated based on the data in the field. As mentioned above, the field can vary based on an availability of data within the data record, and the data records can vary based on type. How the summary is generated may vary based on the type of record and the field selected. Based on this information, how to generate the summary is determined at step 306. Step 306 may, for example, involve retrieving a template corresponding to the record or the field. A template corresponding to a given record type may identify how to present data found in that record type.

Finally, using this information, the summary of the data record is generated at step 308. For example, the summary may be generated by inserting data from identified data fields into corresponding portions of the retrieved template. In this way, the format of the data record summary is consistent across all summaries, regardless of whether the underlying data records are of different types.

### System

FIG. 4 is a diagram illustrating an example system 400 for generating an interface that presents a patent's disparate medical data on a unified timeline, according to an embodiment. System 400 includes a client 402 and server 410 connected by one or more networks 404, such as the Internet. Server 410 is also coupled to a medical records database 420. Server 410 may be part of a comprehensive EHR system, as described in further detail below.

Client 402 may, for example, include a web browser that enables a user to browse through an EHR system. The web browser responds to user input, such as user selection of different portions of an interface, by sending an HTTP request to server 410 via network 404. In another example, the user may interface with client 402 through a native application instead of a web browser, such that the native application communicates with server 410. Client 402 may be any type of computing device, such as and without limitation, a PC, laptop, or mobile device.

To respond to the request from client 402, server 410 may operate as described above for FIGS. 2 and 3. In the embodiment of FIG. 4, server 410 includes four modules: query module 412, summary module 414, timeline module 416, and interface module 418. Each module is described below in turn.

Query module 412 receives a request for medical data about a patient and identifies, in a medical records database 420, data records that relate to the patient. To identify which data records relate to the patient, query module 412 may generate one or more queries. A query may identify at least one table in medical records database 420, and may specify one or more records in the table to return. To specify which records in the table to return, the query may identify the selected patient. Query module 412 may send the query to medical records database 420. Upon retrieval of the requested records, query module 412 sends the retrieved records back to client 402.

Medical records database 420 stores a plurality of different types of medical records. Each data record stored in medical records database 420 has a corresponding time. The time may be a timestamp including both a date and time and signifying when the event described by the medical record occurred. Medical records database 420 may be any type of structured data store, including a relational database.

As illustrated in FIG. 4, medical records database 420 may store the medical data in a plurality of different medical data tables 424A, B, . . . . Each table may store a different type of medical data. For example, medical data table 424A may store records of patient encounters, medical data table 424B may store records of referrals, and so on. To avoid having to query these tables individually to gather all the data needed to generate the timeline, medical records database 420 may also include an index table 422. In an embodiment, query module 412 queries index table 422 to retrieve the data needed for the timeline. The index table may point to rows in medical data tables 424, which include the complete records. Or, in an embodiment where the database is de-normalized, the index table may itself include the medical data needed to generate the summary. In this way, by querying a single table to retrieve disparate information for the timeline, index table 422 may improve performance.

For each data record retrieved, summary module 414 generates a summary. To generate the summary, summary module 414 may be programmed with different hierarchies and templates for different data types. For each data record retrieved, summary module 414 determines, based on a type of the data record, which template and hierarchy of fields corresponds to the data record's type. Then, according to the priority specified in the hierarchy, summary module 414 iterates through fields to determine one or more available fields in the data record to present in the summary. Finally, summary module 414 generates the summary describing the data record based on the template and the field(s).

Timeline module 416 temporally orders the summaries into a timeline. In an embodiment, timeline module 416 orders the summaries in reverse chronological order. In this way, the timeline illustrates the history of the patient's care.

Interface module 418 outputs the timeline for display. Interface module 418 may output the timeline by transmitting it, via network 404, to client 402. Then, client 402 displays the timeline on a user display. The displayed timeline presents the plurality of different types of data records about the patient together in a single view.

Once the timeline is displayed to a user, the user may have several options for filtering (e.g., narrowing down) the displayed data. The interface may include, for example, user interface widgets for filtering the data based on type or for searching the data. Using these widgets, a user may specify a subset of the data in the timeline. In response to the user input, an updated view may be generated that temporally presents the subset, such as in reverse chronological order. The updated view may be generated by client-side code on client 402 (e.g., JavaScript embedded in a page provided by server 410). Or, client 402 may send a request to server 410, which uses interface module 418 to generate the updated view. Other methods of rendering would be evident to a skilled artisan. Either way, client 402 or server 410 outputs the updated view for display.

Each of the servers and modules in FIG. 4 may be implemented on the same or different computing devices in hardware, software, or any combination thereof. Such computing devices can include, but are not limited to, a personal computer, a mobile device such as a mobile phone, workstation, embedded system, game console, television, set-top box, or any other computing device. Further, a computing device can include, but is not limited to, a device having a processor and memory, including a nontransitory memory, for executing and storing instructions. The memory may tangibly embody the data and program instructions. Software may include one or more applications and an operating system. Hardware can include, but is not limited to, a processor, memory, and graphical user interface display. The computing device may also have multiple processors and multiple shared or separate memory components. For example, the computing device may be a part of or the entirety of a clustered computing environment or server farm.

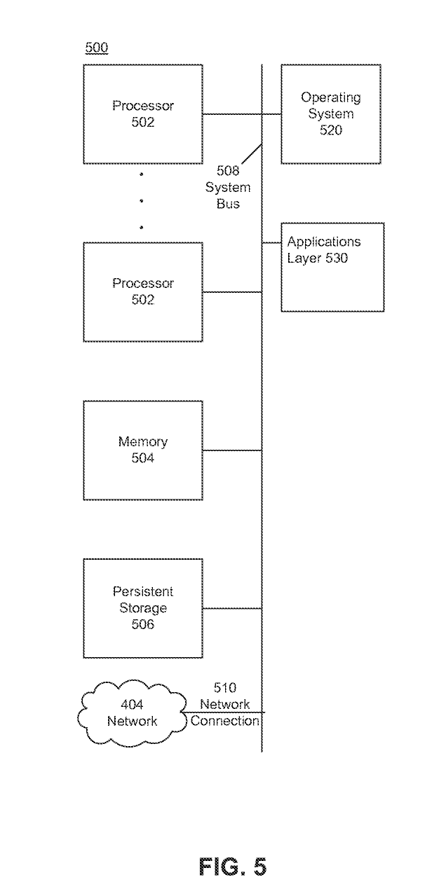

An example computing device is illustrated in FIG. 5. FIG. 5 is a diagram illustrating a computing device 500 that accesses a network 404 over a network connection 510 that provides computing device 500 with telecommunications capabilities. Computing device 500 uses an operating system 520 as software that manages hardware resources and coordinates the interface between hardware and software.

In an embodiment, computing device 500 contains a combination of hardware, software, and firmware constituent parts that allow it to run an applications layer 530. Computing device 500, in embodiments, may be organized around a system bus 508, but any type of infrastructure that allows the hardware infrastructure elements of computing device 500 to communicate with and interact with each other may also be used.

Processing tasks in the embodiment of FIG. 5 are carried out by one or more processors 502. However, it should be noted that various types of processing technology may be used here, including multi-core processors, multiple processors, or distributed processors. Additional specialized processing resources such as graphics, multimedia, or mathematical processing capabilities may also be used to aid in certain processing tasks. These processing resources may be hardware, software, or an appropriate combination thereof. For example, one or more of processors 502 may be a graphics-processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

In order to manipulate data in accordance with embodiments describe herein, processors 502 access a memory 504 via system bus 508. Memory 504 is nontransitory memory, such as random access memory (RAM). Memory 504 may include one or more levels of cache. Memory 504 has stored therein control logic (i.e., computer software) and/or data. For data that needs to be stored more permanently, processors 502 access persistent storage 506 via system bus 508. Persistent storage 506 may include, for example, a hard disk drive and/or a removable storage device or drive. A removable storage drive may be an optical storage device, a compact disc drive, flash memory, a floppy disk drive, a magnetic tape drive, tape backup device, and/or any other storage device/drive.

Processors 502, memory 504, and persistent storage 506 cooperate with operating system 520 to provide basic functionality for computing device 500. Operating system 520 provides support functionality for applications layer 530.

Network connection 510 enables computer device 500 to communicate and interact with any combination of remote devices, remote networks, remote entities, etc. For example, network connection 510 may allow computer device 500 to communicate with remote devices over network 404, which may be a wired and/or wireless network, and which may include any combination of LANs, WANs, the Internet, etc. Control logic and/or data may be transmitted to and from computer device 500 via network connection 510.

Applications layer 530 may house various modules and components. For example, query module 412, summary module 414, timeline module 416, and interface module 418 may be included in applications layer 530 when computing device 500 is used as server 410.

It should be noted that computer-readable medium embodiments may include any physical medium which is capable of encoding instructions that may subsequently by used by a processor to implement methods described herein. Example physical media may include floppy discs, optical discs (e.g. CDs, mini-CDs, DVDs, HD-DVD, Blu-ray), hard drives, punch cards, tape drives, flash memory, or memory chips. However, any other type of tangible, persistent storage that can serve in the role of providing instructions to a processor may be used to store the instructions in these embodiments.

### Comprehensive EHR System

A comprehensive EHR system includes a variety of components. Components of EHR systems vary from vendor to vendor and from setting to setting. For example, an EHR system in which embodiments of the present invention can be used may also include: (1) an electronic prescription (eRx) component, (2) a clinical and radiology laboratory component, (3) a transfer of care component, (4) a scheduling component, (5) a billing service component, and (6) patient portal component.

The electronic prescription component provides medical professionals capabilities to electronically generate and transmit prescriptions for patients' medications. Some EHR systems enable prescribers to view their patients' prescription benefit information at the point of care and select medications that are on formulary and covered by the patient's drug benefit. This informs physicians of potential lower cost alternatives (such as generic drugs) and reduces administrative burden of pharmacy staff and physicians related to benefit coverage.

The clinical and radiology laboratory component allows medical professionals to integrate with clinical laboratories to electronically receive and incorporate clinical laboratory tests and results into a patient's chart and create computerized provider order entry (“CPOE”) clinical laboratory orders. This component can also support functionality that enables medical professionals to electronically receive and incorporate radiology laboratory test results (e.g., x-ray, ultrasound, MRI, PET/CT scan, mammography) into a patient's chart.

Medical professionals can use the transfer of care component to transmit referrals electronically to other EHR users or to non-users by facsimile. Additionally, some EHR systems support electronically creating and transmitting consolidated continuity of care documents.

The scheduling component offers functionality that allows healthcare providers to manage their appointments with an electronic schedule that can be integrated into a practice's workflow.

The billing service component offers medical professionals the ability to electronically generate and transmit superbills. Superbills are the data source for the creation of a healthcare claim. The billing service component can transmit superbills to medical billing software accounts controlled by the professionals' offices or their billing service providers. This component also allows a healthcare professional to save a superbill and transmit it to the health care professional's billing account with the billing software vendor.

The patient portal component allows medical professionals to grant their patients an online means to view, download, and transmit their health information, often called the personal health record (PHR). This component also provides patients with the ability to review their physicians and send and receive secure messages directly to and from their physicians.

Together, these components leverage the benefits of EHRs while mitigating the risks.

### CONCLUSION

Identifiers, such as “(a),” “(b),” “(i),” “(ii),” etc., are sometimes used for different elements or steps. These identifiers are used for clarity and do not necessarily designate an order for the elements or steps.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method for presenting medical data, comprising:
(a) receiving, on a computing device, a request for medical data related to a patient;
(b) identifying, on the computing device, which data records in a medical records database relate to the request, the medical records database including a plurality of different types of medical data records, wherein the respective data records each comprise a plurality of fields, including a corresponding time;
for respective data records identified in (b):
(c) determining, on the computing device, based on a type of the data record, a template describing how to present a data field of the data record;
(d) generating, on the computing device, a data record summary that describes the data record based on the template determined in (c), the data record summary presenting one or more fields as specified by the template, such that the data record summary is formatted consistently with summaries of other data records having a different type and in accordance with a determined hierarchy of fields in the data record;
(e) temporally ordering, on the computing device and according to the data records' corresponding times, the identified data records to generate a timeline; and
(f) outputting, from the computing device, the timeline to a device for display, such that the displayed timeline presents the medical data records related to the request together in a single temporal view, wherein the medical data records are displayed according to their respective data record summaries.

2. (canceled)

3. The method of claim 1, wherein generating (d) comprises, for respective data records:
iterating through the hierarchy of fields to identify one or more fields in the data record to present in the summary.

4. The method of claim 1, wherein the ordering (e) comprises ordering the data records in reverse chronological order.

5. The method of claim 1, wherein the plurality of different types of medical data include: a record of an encounter, a record of a referral, a record of a message, and a record of a laboratory result.

6. The method of claim 1, wherein the plurality of different types of medical data are each stored in a different table in the medical records database, wherein the identifying (b) comprises querying an index table stored in the medical records database, the index table pointing to records in the different tables.

7. The method of claim 1, further comprising:
(g) receiving a user input from the device displaying the timeline, the user input specifying a subset of the timeline's data; and
(h) in response to the user input, outputting the subset for display.

8. The method of claim 1, further comprising:
(g) receiving a user input from the device displaying the timeline, the user input identifying a record presented in the timeline; and
(h) in response to the user input, outputting for display the record in greater detail.

9. A system for presenting medical data, comprising:
a computing device;
a medical records database that stores a plurality of different types of medical data records, each data record comprising a plurality of fields, including a corresponding time;
a query module, implemented on the computing device, that receives a request for medical data related to a request and identifies which data records in a medical records database relate to the patient;
a summary module that, for respective data records identified as related to the patient: (0 determines, based on a type of the data record, a template describing how to present a data field of the data record, and (ii) generates a data record summary that describes the data record based on the template, the summary presenting one or more fields as specified by the template, such the data record summary is formatted consistently with summaries of other data records having a different type and in accordance with a determined hierarchy of fields in the data record;
a timeline module, implemented on the computing device, that temporally orders, according to the data records' corresponding time, the identified data records to generate a timeline; and
an interface module, implemented on the computing device, that outputs the timeline to another device for display, such that the displayed timeline presents the medical data records related to the request together in a single temporal view.

10. (canceled)

11. The system of claim 9, wherein the respective data records each include a plurality of fields, and wherein the summary module, for respective data records identified to be related to the patient: (iii) determines, based on a type of the data record, a hierarchy of fields in the data record; and (iv) iterates through the hierarchy of fields to identify one or more fields in the data record to present in the summary.

12. The system of claim 9, wherein the timeline module orders the data records in reverse chronological order.

13. The system of claim 9, wherein the plurality of different types of medical data include a record of an encounter, a record of a referral, a record of a message, and a record of a laboratory result.

14. The system of claim 9, wherein the medical records database includes a plurality of different tables, each storing a different type of medical data, wherein the query module queries an index table stored in the medical records database, the index table pointing to records in the different tables.

15. The system of claim 9, wherein the interface module: (i) receives a user input from the device displaying the timeline, the user input specifying a subset of the timeline's data, and (ii) in response to the user input, outputs the subset for display.

16. The system of claim 9, wherein the interface module: (i) receives a user input from the device displaying the timeline, the user input identifying a record presented in the timeline, and (ii) in response to the user input, outputs for display the record in greater detail.

17. A non-transitory computer-readable medium embodying a program of instructions executable by at least one machine to perform a method for presenting medical data, said method comprising:
(a) receiving a request for medical data related to a patient;
(b) identifying which data records in a medical records database relate to the patient, the medical records database including a plurality of different types of medical data records, wherein the respective data records each comprise a plurality of fields, including a corresponding time;
for respective data records identified in (b):
(c) determining, based on a type of the data record, a template describing how to present a data field of the data record;
(d) generating a data record summary that describes the data record based on the template determined in (c), the data record summary presenting one or more fields as specified by the template, such that the data record summary is formatted consistently with summaries of other data records having a different type and in accordance with a determined hierarchy of fields in the data record;
(e) temporally ordering, according to the data records' corresponding times, the identified data records to generate a timeline; and
(f) outputting the timeline to a device for display, such that the displayed timeline presents the medical data records related to the request together in a single temporal view, wherein the medical data records are displayed according to their respective data record summaries.

18. (canceled)

19. The computer-readable medium of claim 17, wherein generating (d) comprises, for respective data records:
(i) iterating through the hierarchy of fields to identify one or more fields in the data record to present in the summary.

20. The computer-readable medium of claim 17, wherein the ordering (e) comprises ordering the data records in reverse chronological order.

21. A computer-implemented method for presenting personal data, comprising:
(a) receiving, at a computing device, a request for a data related to a person;
(b) determining, at the computing device, which data records in a database are related to the person, the database including a plurality of different types of personal data and each data record, wherein the respective data records each comprise a plurality of fields, including a corresponding time;
for respective data records identified in (b):
(c) determining, at the computing device, based on a type of the data record, a template describing how to present a data field of the data record;
(d) generating, at the computing device, a data record summary that describes the data record based on the template determined in (c), the data record summary presenting one or more fields as specified by the template, such that a format of the data record summary is consistent with summaries of other data records having a different type and in accordance with a determined hierarchy of fields in the data record;
(e) temporally ordering, at the computing device, according to the data records' corresponding time, the determined data records determined to generate a timeline; and
(f) outputting for display the timeline generated in (c) such that the displayed timeline presents the plurality of different types of data records related to the person together in a single temporal view.
